(19) United States
(12) Patent Application Publication
(10) Pub. No.: US 2006/0291677 A1
(43) Pub. Date: Dec. 28, 2006

(54) High-fidelity piezoelectric contact-type microphone structure

(75) Inventor: Ching-Tsai Chou, Tai-Chung Hsien (TW)

Correspondence Address: BACON & THOMAS, PLLC, 625 SLATERS LANE, FOURTH FLOOR, ALEXANDRIA, VA, 22314, US

(73) Assignee: AirDigit Incorporation, Hinch City (TW)

(21) Appl. No.: 11/148,233

(22) Filed: Jun. 9, 2005

(51) Int. Cl. H04R 25/00

(52) U.S. Cl. 381/190

(57) ABSTRACT

A piezoelectric contact-type microphone structure is provided. With this structure, the piezoelectric element directly touches the speaker's skin without the intervening sponge or spring to fully pick up the skin vibration and to avoid high-frequency attenuation. The structure also provides an ample room for the piezoelectric element to undergo full structural change. The structure avoids the low-frequency distortion resulted from a resonance structure formed by the piezoelectric element, the sponge or spring, and the casing of the microphone. A microphone using this structure has a flat frequency response and a superior performance both for high- and low-frequency voice signals.

### BACKGROUND OF THE INVENTION

1. Field of the Invention

The present invention generally relates to microphone devices, and more particularly to a structure for piezoelectric contact-type microphones.

2. The Prior Arts

Microphones have been part of people's life for many years but only until recently, due to the widespread popularity of portable electronic devices such as mobile handsets and MP3 players, they have regained people's attention.

Conventional capacitive microphones receive voice signals by sensing the vibration of air caused by audio sources such as loudspeakers, people's vocal cords, etc. As the environmental noises are collected as well, capacitive microphones are not appropriate in a noisy environment. In addition, when the speaker is wearing a respirator, a gas mask, a helmet, or similar device that would block the propagation of voice, capacitive microphones are not appropriate either.

Another type of commonly seen microphones is the so-called piezoelectric contact-type microphone. This type of microphones picks up the speaker's voice by directly touching the speaker's skin and sensing the vibration of the speaker's skin, muscle, and skeleton. Since the propagation of voice is not via the noise-prone air, piezoelectric contact-type microphones are very much suitable in a noisy environment and for speakers wearing a respirator, gas mask, or helmet.

FIGS. 1a and 1b are schematic diagrams showing the skin contacting section of two conventional piezoelectric contact-type microphones. As illustrated, the piezoelectric element 10 is usually plated on its both top and bottom sides with metallic films 12 and 14. The side with the metallic film 12 is attached to a metallic plate 11, which in turn has a conducting wire 13 attached to it as one of the piezoelectric element 10's two electrodes for signal output. Another conducting wire 15 is attached to the metallic film 14 as the other electrode. The conducting wires 13 and 15 are then connected to a circuit board containing an amplification circuit (not shown).

In the conventional piezoelectric contact-type microphones, there is usually a buffering member installed between the casing 16 and the metallic film 14. This buffering member could be a sponge 18 or object made of similar material as shown in FIG. 1a, or it could be a spring 19 as shown in FIG. 1b, so as to transmit the pressure P exerted on the casing 16 from the skin, muscle, or skeleton.

Experiments have discovered that, for these conventional piezoelectric contact-type microphones, high-frequency voice signals are severely attenuated as the weak, high-frequency vibrations caused by these high-frequency voice signals are absorbed by the sponge 18 or the spring 19. These conventional piezoelectric contact-type microphones therefore suffer significant high-frequency distortion.

In addition, as shown in FIGS. 1a and 1b, the piezoelectric element 10, the buffering member (the sponge 18 or the spring 19), and the casing 16 jointly form an airtight structure, which would cause low-frequency resonance and reinforce the low-frequency echo. These conventional piezoelectric contact-type microphones therefore also suffer significant low-frequency distortion.

### SUMMARY OF THE INVENTION

The major objective of the present invention is therefore to provide an improved structure for piezoelectric contact-type microphones that prevents the distortions at the high- and low-frequency ranges without sacrificing the advantages of piezoelectric contact-type microphones.

A major feature of the present invention is the omission of the sponge or spring inside the microphone so that the piezoelectric element could directly and fully pick up the vibration of skin, muscle, and skeleton, instead of indirectly through the sponge and spring. On the other hand, the empty space inside the microphone from the mission of the sponge or spring allows the piezoelectric element to have the greatest extent of structural change when picking up the vibration. The piezoelectric element therefore could accumulate the greatest amount of charge, which in turn would produce the largest signal output voltage. If further the dimension of the piezoelectric element is reduced to a certain size (for example, a round piezoelectric element has a diameter smaller than 8 mm), as experiments have discovered, the microphone would have a rather flat frequency response up to 10,000 Hz.

Another major feature of the present invention is that through openings are arranged on the body of the microphone so that the structure of the microphone does not form a low-frequency resonant structure and the microphone's low-frequency response is improved.

The performance of the present invention is vividly illustrated with reference to FIGS. 2a and 2b. As shown in FIG. 2a, which is a frequency response diagram of a conventional piezoelectric contact-type microphone, there are severe distortions for voice signals both at low and high frequencies such as those above 8,000 Hz. On the contrary, FIG. 2b, which is a frequency response diagram of a piezoelectric contact-type microphone according to the present invention, shows that, in addition to a better low-frequency response, voice signals have to be above 10,000 Hz to suffer noticeable attenuation. The piezoelectric contact-type microphones according to the present invention therefore are much more superior to the conventional ones.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIGS. 1a and 1b are schematic diagrams showing the skin contacting section of two conventional piezoelectric contact-type microphones.

FIG. 2a is a frequency response diagram of a conventional piezoelectric contact-type microphone.

FIG. 2b is a frequency response diagram of a piezoelectric contact-type microphone according to the present invention.

FIGS. 3a and 3b are schematic diagrams showing a top and side views of a piezoelectric element respectively according to a first embodiment of the present invention.

FIG. 3c is a schematic diagram showing a perspective view of a piezoelectric contact-type microphone according to a first embodiment of the present invention.

FIG. 3d is a schematic diagram showing a side view of a piezoelectric contact-type microphone according to a first embodiment of the present invention.

FIG. 3e is a schematic diagram showing a side view of a piezoelectric contact-type microphone according to a second embodiment of the present invention.

FIG. 3f is a schematic diagram showing a side view of a piezoelectric contact-type microphone according to a third embodiment of the present invention.

### DETAILED DESCRIPTION OF THE PREFERRED EMBODIMENTS

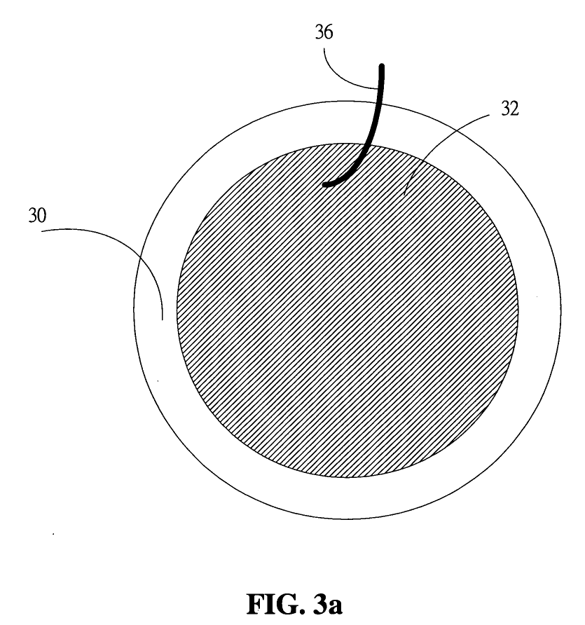

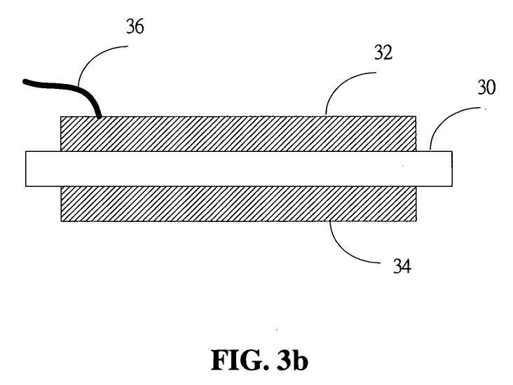

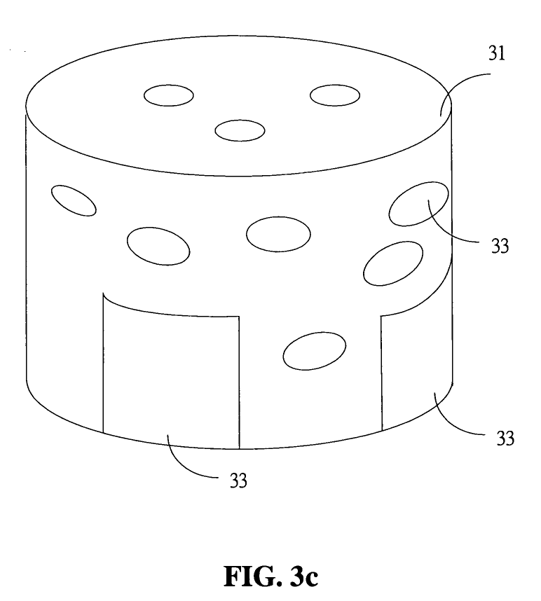

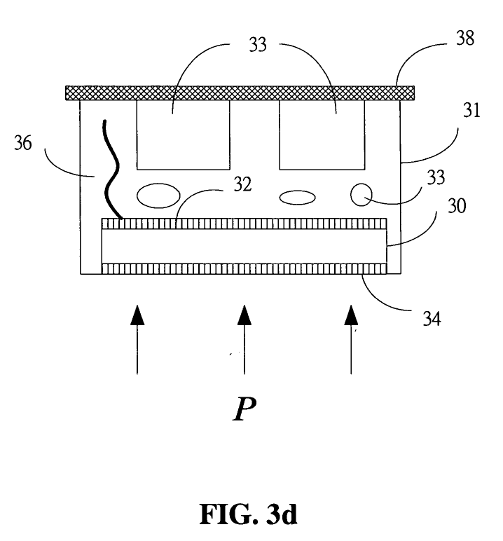

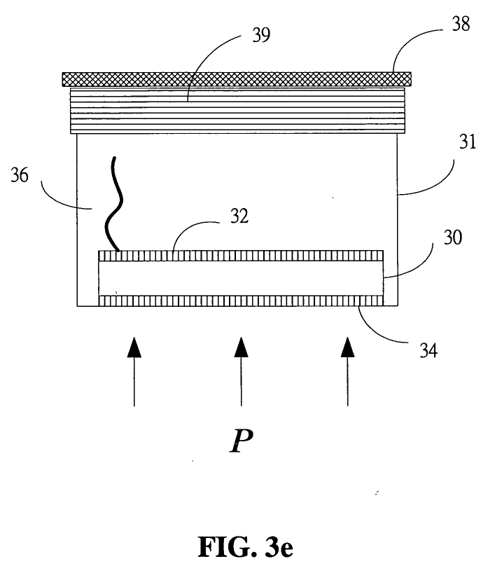

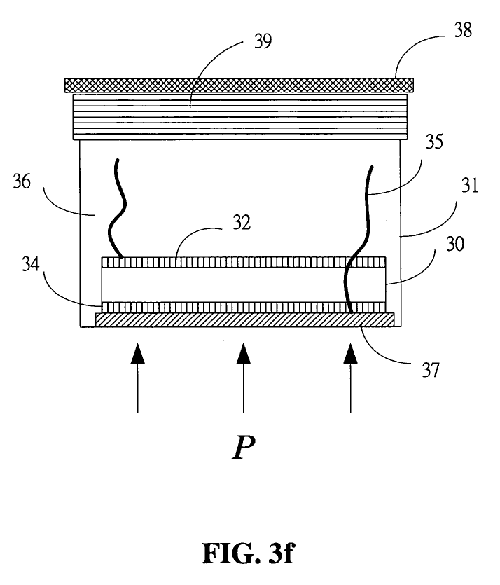

A piezoelectric contact-microphone according to the present invention mainly contains a piezoelectric element, and a main body. FIGS. 3a and 3b are schematic diagrams showing a top and side views of a piezoelectric element respectively according to a first embodiment of the present invention. As illustrated, a flat piezoelectric element 30, usually made of ceramic or quartz, has a round shape. There is actually no specific requirement on the shape of the piezoelectric element 30. Most of the time, a shape is chosen to conform to that of the main body (e.g., a round piezoelectric element for a cylindrical main body). The piezoelectric element 30 is also chosen to have a specific diameter (e.g., 8 mm in the present embodiment) to have a better sense of the pressure P. The top and bottom side of the piezoelectric element 30 are plated with metallic film 32 and 34 respectively, which in general cover almost the entire surfaces of the two sides of the piezoelectric element 30. Metallic films 32 and 34 are usually made of metallic material with high conductivity such as silver. The metallic film 32 (whose resident side is referred to as the first side hereinafter) has a conducting wire 36 soldered to it as one of the two electrodes for output electrical signals from the piezoelectric element 30. In other embodiments, for simplifying the manufacturing process, the conducting wire 36 could be replaced by an elastic conducting strip or a metallic spring.

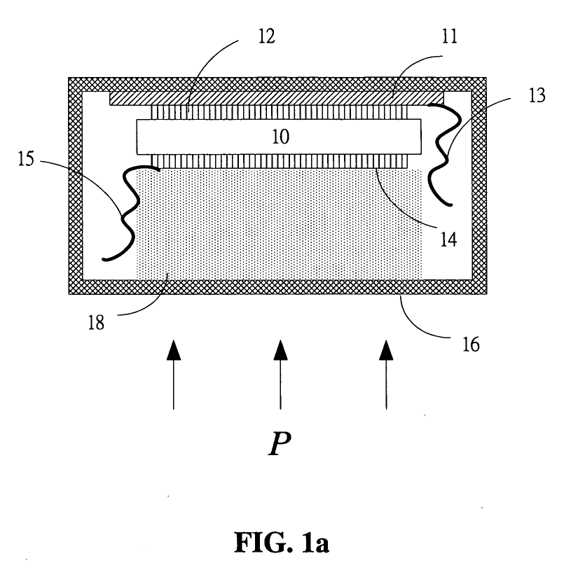

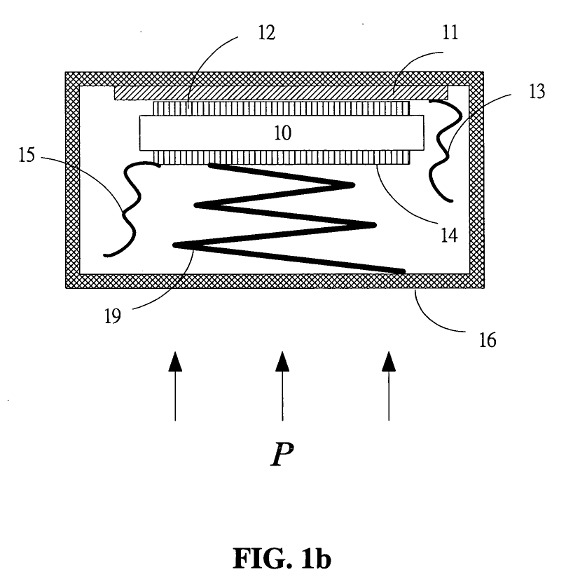

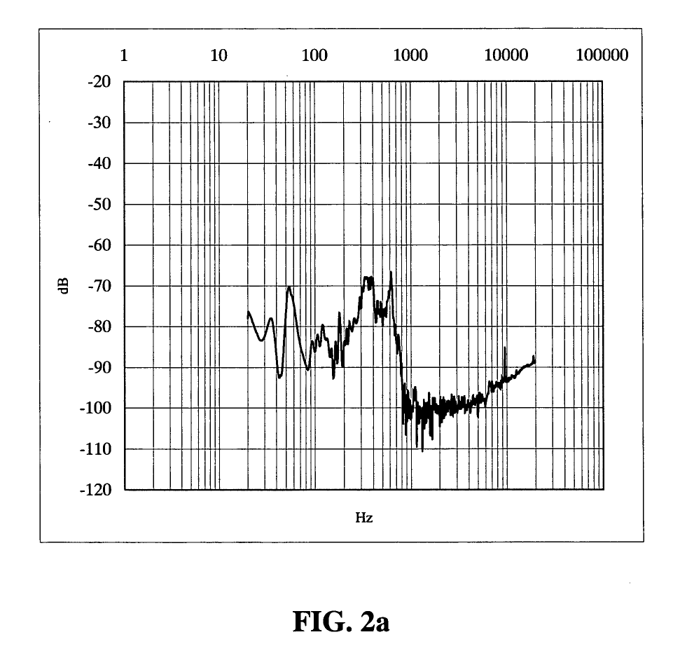

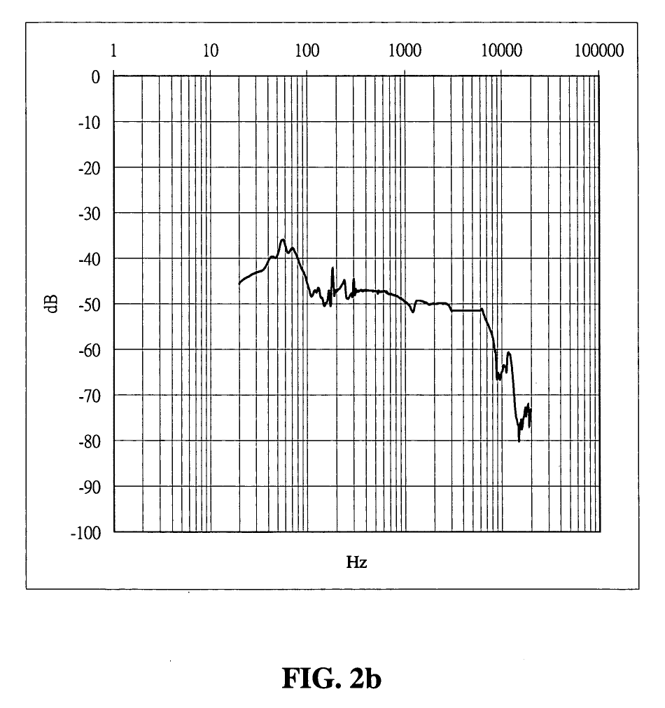

FIG. 3c is a schematic diagram showing a perspective view of a piezoelectric contact-type microphone according to a first embodiment of the present invention. FIG. 3d is a schematic diagram showing a side view of a piezoelectric contact-type microphone according to a first embodiment of the present invention. As illustrated, the main body 31 is a metallic hollow cylinder with a closed end. In other embodiments, the main body 31 is a hollow column with an appropriate length, a closed end, and a cross-sectional shape other than a circle. The piezoelectric element 30 has its second side (the side opposite to the first side) directly attached to the inside of the main body 31's closed end to form a direct electrical contact. The main body 31, on the other hand, has its open end fixed to a positioning member 38. The positioning member 38 could be the circuit board of the microphone, or it could be part of the casing of the microphone, depending on the embodiments. In other words, the main body 31 is like a bucket turning up side down, the piezoelectric element 30's metallic film 34 is directly adhered to the inside of the bucket's bottom, and the empty space inside the bucket provides ample room for the piezoelectric element 30 to undergo structural change resulted from the skin, muscle, and skeleton vibration. The metallic film 34 of the piezoelectric element 30 and the metallic main body 30 constitute jointly one of the electrodes of the piezoelectric element 30. The conducting wire 36 (as another electrode of the piezoelectric element 30) and the metallic main body 31 then are attached to the circuit board containing the amplification circuit. One of the advantages of the present invention is that, with reference to FIGS. 1a and 1b, the metallic plate 11 and the conducting wire 13 are omitted. Please note that, as illustrated in FIG. 3c, the closed end of the main body 31 could have a number of through openings (not numbered). The purpose of these openings is that, if the piezoelectric element 30 is attached to the inner side of the main body 31's closed end using an adhesive, extraneous adhesive could leak through the openings without causing too thick an adhesive layer.

Generally, the piezoelectric element 30 gets in touch with the speaker's skin only via the metallic film 34 and the main body 31. In some embodiments, the main body 31 is wrapped or covered by a piece of cloth. As the sponge or spring commonly found in conventional microphones is omitted, the piezoelectric element 30 could sense the pressure P from the skin, muscle, and skeleton directly. Please note that it is mentioned earlier that the conducting wire 36 could be replaced by an elastic conducting strip or a metallic spring. This strip or spring is not positioned between the piezoelectric element 30 and the skin, but on the other side of the piezoelectric element 30. Since the main body 31 has an appropriate length and there is only empty space but no obstacle beneath the piezoelectric element 30 and the metallic film 32, the piezoelectric element 30 could have the greatest extent of structural change under the pressure P, an largest amount of charge could be accumulated on the metallic films 32 and 34, and a greatest signal output voltage could thereby be achieved and transmitted to the amplification circuit on the circuit board (not shown).

The foregoing design, along with the reduction of the diameter (or surface area) of the piezoelectric element 30, jointly contributes to the significantly improved high-frequency response of a piezoelectric contact-type microphone according to the present invention. Further more, the omission of the sponge and spring also help to reduce the low-frequency resonance and echo.

In order to further reduce the low frequency resonance, the main body 31 could be configured to have at least a through opening 33 on its cylindrical body. There is no specific requirement either on the shape or position of the opening 33, as illustrated in FIGS. 3c and 3d. The shape of the opening 33 could be a circle, rectangle, or other geometric shape. The opening 33 could be located on the side or along the rim of the open end of the main body 31. Please note that the opening 33 is optional. In addition to the opening 33, a second embodiment of the present invention as illustrated in FIG. 3e has a rigid seat 39 positioned between the main body 31 and the positioning member 38. Again, there is no specific requirement on the form factor of the seat 39. However, its dimension is usually such that it could accommodate the open end of the main body 31. The material used to make the seat 39, metallic or non-metallic, is of no significance. The most important requirement to the seat 39 is that it possesses a certain degree of rigidity so that, through its involvement, the resonance of the main body 31 and the positioning member 38 with the skin's vibration is reduced. In some embodiment, for example when the present invention is applied to a wired microphone, the seat 39 and the positioning member 38 (which is part of the casing) are actually combined into a single element, instead of two. Please also note that, if the positioning member 38 has enough rigidity, the seat 39 is not required. Please also note that, in FIG. 3e, there is no opening 33 on the main body 31. If required, the seat 39 and the opening 33 could be implemented together in making a microphone of the present invention.

FIG. 3f is a schematic diagram showing a side view of a piezoelectric contact-type microphone according to a third embodiment of the present invention. The present embodiment has a structure very similar to the previous embodiments. The major differences lie in that the main body 31 is made of a non-metallic material, and a metallic plate 37 is positioned between the metallic film 34 and the inner side of the main body 31's closed end. A conducting wire 35 is soldered to the metallic plate 37 or the metallic film 34, as one of the electrodes of the piezoelectric element 30. The conducting wire 35 and the conducting wire 36 (as the other electrode) are then connected to the amplification circuit on the circuit board (not shown). The present embodiment could also have those implementation variations as mentioned above. For example, the main body 31 could have at least a through opening 33 to reduce low-frequency resonance, the seat 39 could be omitted, etc.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A piezoelectric contact-type microphone structure, comprising:
a main body having a hollow column shape with a closed end and an opposite open end, said main body made of a metallic material, said main body fixedly attached at said open end to a positioning member of said piezoelectric contact-type microphone; and
a piezoelectric element having a flat shape and a specific dimension, said piezoelectric element having a first and second sides plated with a first and second metallic films respectively, a conducting wire attached to said first metallic film, said second side attached to an inner side of said closed end of said main body such that said second metallic film forming an electrical contact with said main body;
wherein an electrical signal from said piezoelectric element is transmitted to a circuit board of said piezoelectric contact-type microphone via said conducting wire and said main body, and said main body has an appropriate column length to provide a space allowing a full structural change of said piezoelectric element.

2. The piezoelectric contact-type microphone structure as claimed in claim 1, wherein said main body has at least a through opening on its column side.

3. The piezoelectric contact-type microphone structure as claimed in claim 1, further comprising a seat having an appropriate rigidity positioned between said main body and said positioning member, said seat having a side accommodating said open end of said main body, said seat having another side attached to said positioning member.

4. The piezoelectric contact-type microphone structure as claimed in claim 1, wherein said positioning member is said circuit board of said piezoelectric contact-type microphone.

5. The piezoelectric contact-type microphone structure as claimed in claim 1, wherein said positioning member is part of a casing of said piezoelectric contact-type microphone.

6. The piezoelectric contact-type microphone structure as claimed in claim 1, wherein said closed end of said main body has at least a through opening.

7. A piezoelectric contact-type microphone structure, comprising:
a main body having a hollow column shape with a closed end and an opposite open end, said main body fixedly attached at said open end to a positioning member of said piezoelectric contact-type microphone; and
a piezoelectric element having a flat shape and a specific dimension, said piezoelectric element having a first and second sides plated with a first and second metallic films respectively, a first conducting wire attached to said first metallic film;
wherein a metallic plate is positioned between said second side of said piezoelectric element and an inner side of said closed end of said main body, a second conducting wire is attached to said metallic plate, an electrical signal from said piezoelectric element is transmitted to a circuit board of said piezoelectric contact-type microphone via said first and second conducting wires, and said main body has an appropriate column length to provide a space allowing a full structural change of said piezoelectric element.

8. The piezoelectric contact-type microphone structure as claimed in claim 7, wherein said main body has at least a through opening on its cylindrical body.

9. The piezoelectric contact-type microphone structure as claimed in claim 7, further comprising a seat having an appropriate rigidity positioned between said main body and said positioning member, said seat having a side accommodating said open end of said metallic main body, said seat having another side attached to said positioning member.

10. The piezoelectric contact-type microphone structure as claimed in claim 7, wherein said positioning member is said circuit board.

11. The piezoelectric contact-type microphone structure as claimed in claim 7, wherein said positioning member is part of a casing of said piezoelectric contact-type microphone.

12. The piezoelectric contact-type microphone structure as claimed in claim 7, wherein said closed end of said main body has at least a through opening.
